(19) United States
(12) Patent Application Publication
(10) Pub. No.: US 2016/0236099 A1
(43) Pub. Date: Aug. 18, 2016

(54) Dome System

(71) Applicants: John Follmer, Santa Monica, CA (US); Tim Sassoon, Venice, CA (US); John Follmer, Santa Monica, CA (US); Tim Sassoon, Venice, CA (US)

(72) Inventors: John Follmer, Santa Monica, CA (US); Tim Sassoon, Venice, CA (US); John Follmer, Santa Monica, CA (US); Tim Sassoon, Venice, CA (US)

(21) Appl. No.: 15/044,978

(22) Filed: Feb. 16, 2016

Related U.S. Application Data
(60) Provisional application No. 62/116,818, filed on Feb. 16, 2015.

(51) Int. Cl. A63G 1/24; G03B 21/56; A63G 4/00

(52) U.S. Cl. CPC A63G 1/24; A63G 4/00; G03B 21/562

(57) ABSTRACT

A display support structure with an image projection system, an image display system and a locomotive system are configured to move independently within an amusement park ride, attraction or other themed entertainment.

### PRIORITY CLAIM

The present invention claims priority to and the benefit of U.S. Provisional Application No. 62/116,818, the contents of which are incorporated by reference.

### TECHNICAL FIELD

The present invention is generally related to amusement park rides, attractions, or other themed entertainment.

### BACKGROUND

Many modern day amusement park rides, attractions, or other themed entertainment (collectively referred to as “attractions”) employ motion based rides that feature integrated components to deliver the desired experience. People sit, stand, or lay in a rider compartment as it moves through the designed attraction. Many times the attractions are synchronized with a visual component such as projecting a video signal on a screen or display. As people move through the attraction in a rider compartment, the visual component displays the appropriate images thus combining motion and sight into an integrated experience for the rider.

Usually a rider compartment (also referred to in this specification as a “compartment”) containing one or more people is secured to an actuator or multiple actuators responsible for moving the rider compartment throughout the attraction. The visual component of the attraction is achieved by placing displays throughout the path of the attraction. To produce the proper image for each compartment along the path, some attraction configurations use a display aimed at a single passing compartment. In some configurations, multiple displays are secured at one location wherein each display is aimed at single compartment. Some of these configurations attach each display to a rotating carousel. As multiple compartments pass by the carousel, the carousel rotates so that the visual component for that particular location can be displayed to multiple compartments at once. For example, U.S. Pat. No. 8,137,205 describes a motion-based attraction that uses a carousel configuration. The carousel configuration enables an increase of an attraction's throughput because multiple displays can be tasked to show the same thing as the carousel rotates. This enables compartments to be placed closer together thus increasing the throughput of the attraction for a given time period.

However, the carousel configuration introduces constraints when designing an attraction. For each visual component, a large carousel full of displays must be employed. When more visual components are desired, more carousels must be employed increasing the cost and size of an attraction. Additionally, once the compartment moves past a carousel, the utility of the particular display ends for that particular compartment. So when adding a visual component, a display is limited to what its carousel location is tasked to display, i.e., the displays are on a closed loop. Such a configuration limits the number of possible paths through a given space and requires that displays be situated in a circular configuration at each viewing location. What is needed is a system and method that increases the utility of a display by enabling independent movement of the display in relation to the passing compartments. Furthermore, it is desired to 1) reduce display characteristics (e.g., the mass of individual displays, the number of display); 2) increase the flexibility for providing a path through an attraction, including track design; 3) be able implement a variable and/or fixed speed for a given display; and 4) increase the independent motion of a display in any direction on any axis for an attraction that would otherwise be required in an attraction utilizing a “closed loop” carousel configuration.

### SUMMARY

While the way in which the present invention addresses the disadvantages of the prior art will be discussed in greater detail below, in general, the present invention provides for independent movement of displays within an attraction. In particular, an independent display system includes a display support structure, an image projection system, an image display system, and a locomotive system.

A method of providing independent displays viewable by guests in individual rider compartments in an attraction comprises the steps of providing individual rider compartments that follow a first travel path through an attraction, providing a display support structure that follows a second travel path through the attraction, independently coinciding the display support structure with an individual rider compartment, and activating functional units attached to the display support structure according to the attraction's program.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description, or may be learned by the practice of the invention.

### BRIEF DESCRIPTION OF THE DRAWINGS

In order to describe the manner in which the advantages and features of the present invention can be obtained, a more particular description of the present invention will be rendered by reference to specific embodiments and examples, which are illustrated in the appended drawings. Understanding that these drawings depict only typical embodiments of the invention and are not therefore to be considered to be limiting of its scope, the present invention will be described and explained with additional specificity and detail through the use of the accompanying drawings in which:

FIG. 1 illustrates an example attraction layout utilizing the display support structures of the present invention.

FIG. 2 an exemplary motor and brake assembly for a track based locomotive system of the present invention.

FIG. 3 illustrates an exemplary configuration of display support structures on a circular track.

FIG. 4 illustrates a section of an exemplary truss support.

### DETAILED DESCRIPTION

Various embodiments of the invention are described in detail below. While specific implementations involving independently moving displays within an attraction are described, it should be understood that their description is merely illustrative and not intended to limit the scope of the various aspects of the invention. A person skilled in the relevant art will recognize that other components and configurations may be easily used or substituted than those that are described here without parting from the spirit and scope of the invention. As will be appreciated by one of ordinary skill in the art, the system may be embodied as a customization of an existing system, an add-on product, and/or a stand-alone system.

As will become apparent from the following descriptions, the present invention enables displays to move independently of other displays within an attraction. In general, the present invention provides a system and method for to allow individual displays to be viewable by guests in individual rider compartments in an attraction. In particular, the present invention provides a display support structure, an image projection system, an image display system, and a locomotive system. In its embodiments, the present invention allows for independent motion of the individual rider compartments that can follow any geometric shape.

For the sake of brevity, conventional data networking, application development and other functional aspects of the systems (and components of the individual operating components of the systems) may not be described in detail. The connecting lines shown in the various figures are intended to represent exemplary functional relationships and/or physical couplings between various elements. It should be noted that many alternative or additional functional relationships or physical connections may be present in a practical system.

The invention may be described in terms of functional block components, optional selections and various processing steps. It should be appreciated that such functional blocks may be realized by any number of hardware and/or software components configured to perform the specified functions. For example, the invention may employ various integrated circuit components, e.g., memory elements, processing elements, logic elements, audio and/or visual elements, input/output elements, wired or wireless communication techniques, and the like, which may carry out a variety of functions under the control of one or more microprocessors or other control devices.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium have computer-readable program code means embodied in the storage medium. Any suitable computer-readable storage medium may be utilized, including hard disks, CD-ROM, optical storage devices, magnetic storage devices, and/or the like.

The computer program instructions may be loaded onto a general purpose computer, special purpose computer, or other programmable data processing apparatus to produce a machine, such that the instructions execute on the computer or other programmable data processing apparatus create means for implementing the functions specified in the flowchart block or blocks. The computer program instructions may also be loaded onto a computer or other programmable data processing apparatus to cause a series of operational steps to be performed on the computer or other programmable apparatus to produce a computer-implemented process such that instructions which execute on the computer or other programmable apparatus provide steps for implementing the functions specified in the flowchart block or blocks.

Similarly, the software elements of the invention may be implemented with any programming, scripting language or web service protocols such as C, C++, C#, Java, COBOL, assembler, and the like. As those skilled in the art will appreciate, the software and hardware elements may be implemented with an operating system such as Microsoft Windows®, UNIX, Apple OS X, MacOS, Linux, and the like.

The display support structure includes any hardware suitably configured to support several functional units as may be needed for a particular application. In general, the display support structure is implemented to carry and support functional units that need to be moved in concert with an attraction's rider compartments. The display support structure may be constructed or fabricated from a variety of materials, including common building materials, wood, cement, plastics, ceramics, metallic or composite materials. The type of material chosen may be based on one or more properties depending on the application within an attraction, for example, mass, support strength, cost, longevity, color, safety and corrosive properties. In some embodiments, the display support structure is constructed from aluminum.

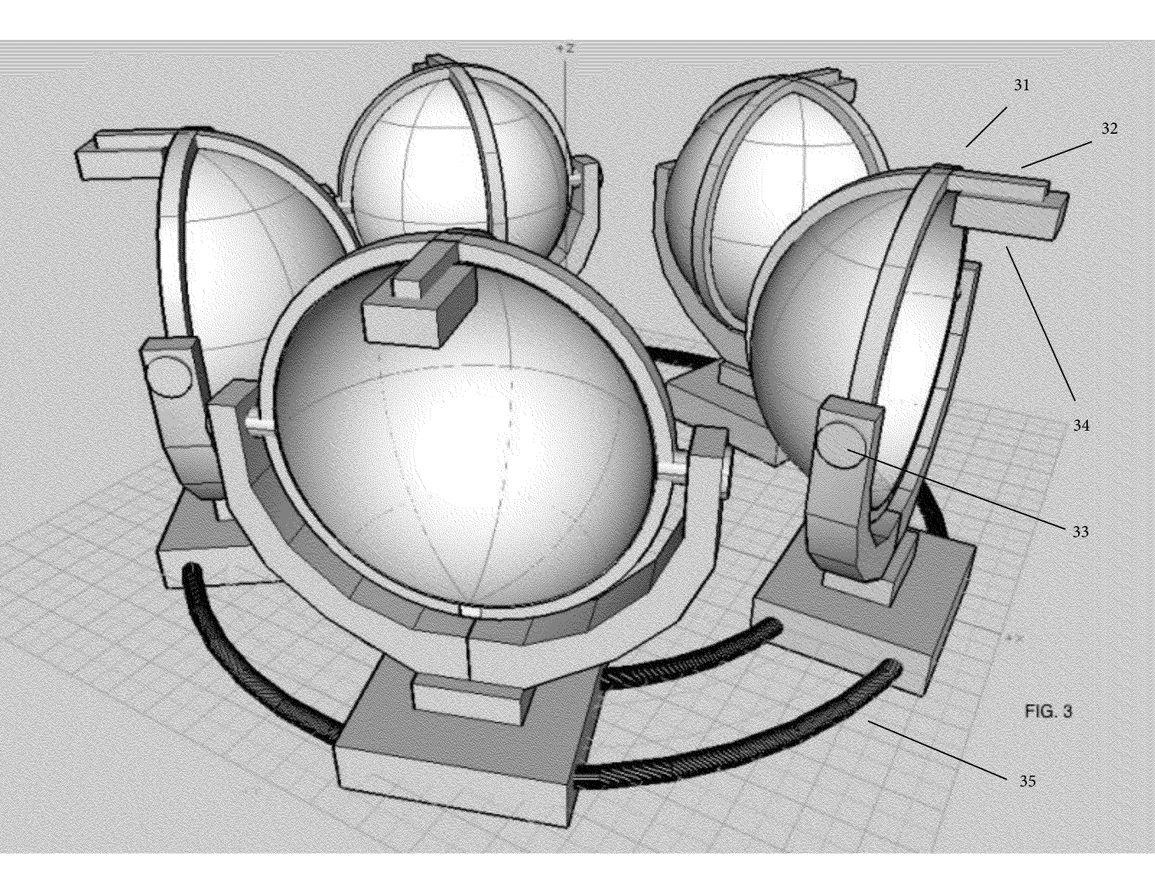

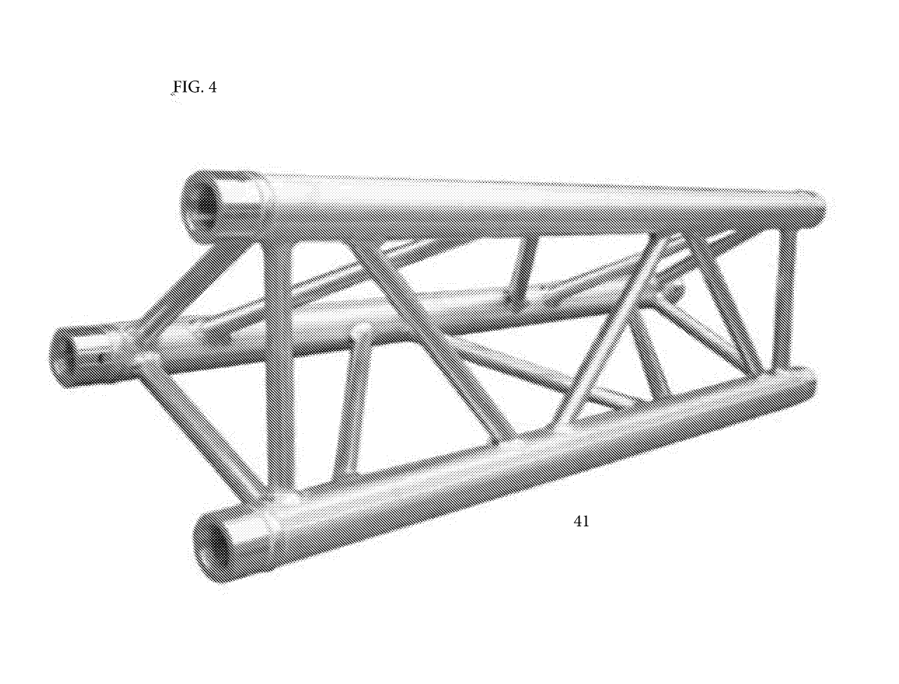

The display support structure 31, as depicted in FIG. 3, is constructed according to the needs of a particular attraction. The construction and the display support structure's configuration and shape must take into account the static, dynamic, shear, rotational, compression and other known forces that may occur in a particular application. In some embodiments, the configuration is implemented as a truss support system. FIG. 4 illustrates a section of an exemplary triangular truss support unit 41. In an exemplary embodiment, the configuration is five or more triangular column units with various connecting nodes creating a tension and compression support structure. In some embodiments, the configuration's shape is a convex dome shape, i.e., one half of a hollow sphere. In the exemplary truss structure embodiment described above, the truss columns form a semi-spherical support system.

The display support structure 31 may utilize functional unit support structures 32 as required by the particular application. These functional unit support structures may be constructed of any material suitable for the particular application and supported by the display support structure. These structures may be placed anywhere on the display support structure construction or configuration depending on the application. Optionally, other functional units may include hardware and/or software suitably configured to provide enhanced or additional attraction experience. For example, various embodiments may include sound, smell, or lighting functions.

Optionally, the display support structure may be constructed so that a portion of the structure may be moved, pivoted, or slid along its three axes 33. In some embodiments, the motion of the portions may be connected to a motor. However, any method or system for providing the necessary force to move, pivot or slide the movable portions is within the scope of the present invention.

The image projection system includes any hardware and/or software suitably configured to generate and project images. Image projection systems are well known and any system capable of generating and projecting images is within the scope of the present invention. In some embodiments, the image projection system is attached to the display support structure. In some embodiments, the image projection system is attached via a functional unit support structure. In an exemplary embodiment, the image projection system comprises a high resolution video projector. In some embodiments, images generated by the image projection system may be digitally processed. In other embodiments, images generated by the image projection system may be processed in analog.

In some embodiments, the image projection system may not attached to the display support structure and the system may be supported by its own support structure. In other embodiments, only portions of the image projection system may be attached to the display support structure. In these embodiments, additional hardware and/or software may be employed so that the portion of the image projection system may operate properly.

The image display system includes any hardware and/or software suitably configured to receive an image for viewing. In various embodiments, the image display system is attached to the display support structure 34. In the exemplary embodiment in which the display support structure is a convex dome shape, the image display system is attached to the rim of the dome. In other embodiments, the image display system may be partially attached to the display support structure.

Various materials are suitable for the image display system. In some embodiments, the image display system is fabric based. In an exemplary fabric based embodiment, the fabric is flexible. In other embodiments, the image display system is rigid material. In yet other embodiments, the image display system is a combination of flexible and rigid materials. In other embodiments, the image display system may be one or more computer or display monitors. In yet other embodiments, the image display system may be a natural material, for example, water or smoke. In an exemplary embodiment, the image display system includes a rigid material. In another exemplary embodiment, the image display system includes stretched fabric. In these embodiments, the fabric or rigid material is placed within the display support structure to create a concave viewing surface. In this embodiment, the image projection system is mounted on the display support system facing the concave viewing surface so that images are projected onto the stretched fabric or rigid material.

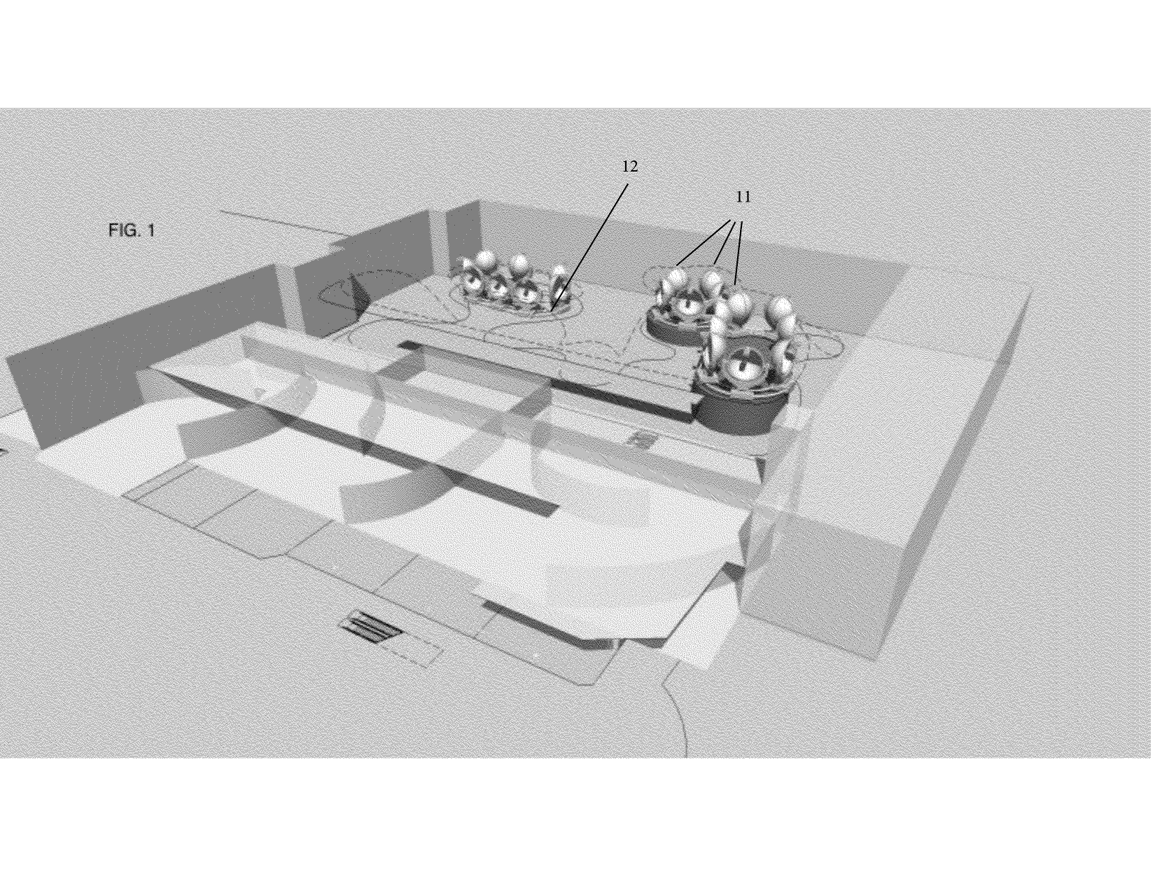

The locomotive system includes any hardware and/or software suitably configured to move and guide an individual display support structure along a path independent of other display support structures. In some embodiments, the guide may be a track, a rail, or some similar structure. In these embodiments, the cross section of the tracks or rails may be of any shape. In an exemplary embodiment, the shape is round. In another exemplary embodiment, the shape is square. In other embodiments, the guide may be focused laser light. FIG. 1 illustrates an example attraction layout utilizing the display support structures of the present invention. All display support structures 11 depicted may move independently of other display support structures along a path 12 within the attraction. While the track's configurations are a closed loop in this example, note that not all are circular. FIG. 3 illustrates an exemplary configuration of display support structures on a circular track 35. Any shape of track is suitable and the track configuration may be open ended or a closed loop.

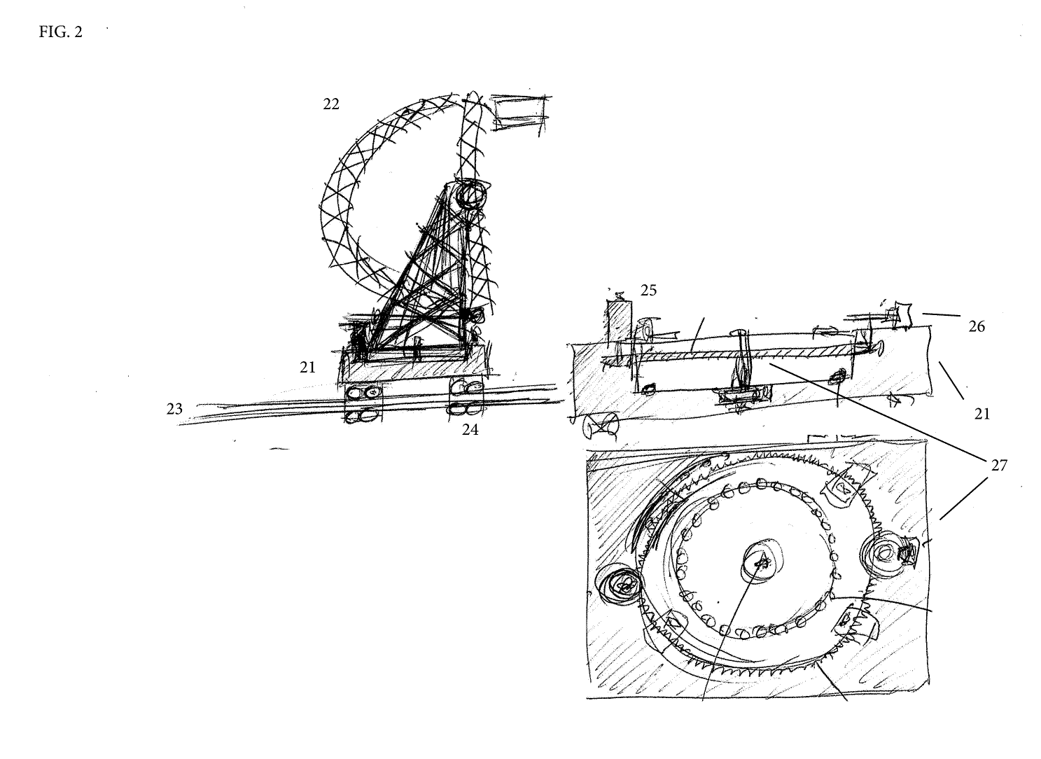

The locomotive system also includes a motor and brake assembly configured to move and stop the display support structures. In an exemplary embodiment using a track as a guide, the motor and brake assembly are attached to the track. FIG. 2 illustrates an exemplary motor and brake assembly for a track based locomotive system. In this embodiment, a motor and brake assembly 21 is operably attached to a display support structure 22. The motor and brake assembly 21 is operably attached to a track 23 through a wheel structure 24 that when actuated enable the complete structure to move along the track. The wheel structure may be comprised of any number of wheels according to the particular application. An exemplary motor and brake assembly 21 is comprised of a motor assembly 25 and a brake assembly 26 operably attached to a gear assembly 27, which in turn is operably attached to the wheel structure 24. The motor and brake assembly 21 may be mounted to the display structure suitable to a particular application.

In its various embodiments, the locomotive system may be attached to a buttressed support, floor, wall, or ceiling depending on the needs of the attraction.

In general, the present invention provides a method of moving individual displays in concert with individual rider compartments in an attraction. In particular, the method may comprise providing individual rider compartments that follow a first travel path through an attraction. Different types of rider compartments are well known and will not be described. The method comprises providing a display support structure that follows a second travel path through the attraction. Depending on the particular attraction, the second path may be close in relationship to the first path. As the rider compartments move through the first path, a display support structure is independently configured to move through the second path. In general, the timing is such that a particular display support structure becomes proximate to a rider compartment so that a rider may view, hear, or otherwise experience the functional units attached to the display support structure. At the appropriate time, the display support structure movement and the functional units may activate to deliver the desired experience to the rider. In an exemplary embodiment, an image projection system and an image display system are attached to the display support structure. In this exemplary embodiment, as the rider compartment travels within sight of the display support structure, the image projection system begins to display images on the image display system.

Although the above description may contain specific details, they should not be construed as limiting the claims in any way. Other configurations of the described embodiments of the invention are part of the scope of this invention. The descriptions and embodiments are not intended to be an exhaustive or to limit the invention to the precise forms disclosed.

What is claimed is:

1. An attraction apparatus having rider compartments configured to move along a first path within an attraction that enable displays directed at the rider compartments to move independently of other displays comprising:
a plurality of display support structures configured to move along a second path within the attraction;
an image projection system directed towards the display support structure configured to generate and project images;
an image display system operably attached to the display support structure and configured to receive the project images from the image projection system; and
a plurality of locomotive systems, each locomotive system operably attached to an individual display support structure configured to move one display support structure independently of another display support structure along the second path within the attraction.

2. The attraction apparatus of claim 1, wherein the display support structure is constructed using a truss support system.

3. The attraction apparatus of claim 1, wherein the display support structure's shape is a convex dome shape.

4. The attraction apparatus of claim 1, further comprising a functional unit support operably attached to a display support structure.

5. The attraction apparatus of claim 1, wherein a portion of the display support structure may be moved, pivoted, or slid along its three axes.

6. The attraction apparatus of claim 1, wherein the image projection system is attached to the display support structure via a functional unit support structure.

7. The attraction apparatus of claim 1, wherein the image projection system is a high resolution video projector.

8. The attraction apparatus of claim 1, wherein the locomotive system comprises a track.

9. The attraction apparatus of claim 1, wherein the locomotive system further comprises a motor assembly and a brake assembly.

10. A method of moving individual displays in concert with individual rider compartments within an attraction, the rider compartments traveling along a first path, the method comprising:
providing a plurality of display support structures;
providing a plurality of locomotive systems moveable along a second path, each locomotive system operably attached to an individual display support structure;
engaging each locomotive system independently according to a timing configured to deliver a desired experience to the rider compartments.

11. The method of claim 10, wherein the display support structure is constructed using a truss support system.

12. The method of claim 10, wherein the display support structure's shape is a convex dome shape.

13. The method of claim 10, further comprising a functional unit support operably attached to a display support structure.

14. The method of claim 10, wherein a portion of the display support structure may be moved, pivoted, or slid along its three axes.

15. The method of claim 10, wherein an image projection system is attached to the display support structure via a functional unit support structure.

16. The method of claim 10, wherein the image projection system is a high resolution video projector.

17. The method of claim 10, wherein the locomotive system comprises a track.

18. The method of claim 10, wherein the locomotive system further comprises a motor assembly and a brake assembly.
